(19) United States
(12) Patent Application Publication
(10) Pub. No.: US 2019/0074684 A1
(43) Pub. Date: Mar. 7, 2019

(54) System and Method for Controlling a String-Level Rapid Shutdown Device for a Solar Panel Array

(71) Applicant: Celestica International LP, Toronto (CA)

(72) Inventors: Aurora CRACIUN, Mississauga (CA); Jeff EIGNER, Longmont, CO (US); Zdenek D. HENES, Waterloo (CA)

(21) Appl. No.: 16/180,963

(22) Filed: Nov. 5, 2018

Related U.S. Application Data
(63) Continuation of application No. PCT/CA2017/050649, filed on May 29, 2017.
(60) Provisional application No. 62/351,767, filed on Jun. 17, 2016.

(51) Int. Cl. H02H 7/20; H02S 50/00; H02S 40/32; H02J 3/38

(52) U.S. Cl. CPC H02H 7/20; H02J 3/383; H02S 40/32; H02S 50/00

(57) ABSTRACT

A string level rapid shut down device, and a method of controlling such a string-level rapid shutdown device in a photovoltaic (PV) solar system comprising one or more strings of PV panels is provided. The method includes, while the rapid shutdown device is on, opening a pair of power switches used by the rapid shutdown device to connect the PV solar panels to an input of an inverter through a DC disconnect switch on an output side. The method also includes determining a rate of voltage decay on the output side while the power switches are open; and controlling the power switches according to the rate of voltage decay.

### CROSS-REFERENCE TO RELATED APPLICATION(S)

This application is a continuation of PCT Application No. PCT/CA2017/050649 filed on May 29, 2017, which claims priority to U.S. Provisional Patent Application No. 62/351,767 filed on Jun. 17, 2016, both incorporated herein by reference.

### TECHNICAL FIELD

The following relates to systems and methods for controlling string-level rapid shutdown devices for solar panel arrays.

### DESCRIPTION OF THE RELATED ART

Photovoltaic (PV) solar panels are typically constructed from a number of individual direct current (DC) PV cells connected in series and parallel. PV panels are also typically connected in series to each other to create a string of panels. Strings of PV panels are often connected in parallel in higher power systems. The strings are connected to an inverter, which converts the DC power generated by the panels into alternating current (AC) power that can be connected to an electrical grid.

Since PV panels produce power whenever they are in the presence of a source of illumination such as sunlight, the panels will continue to generate voltage even when the PV system is disconnected from the electrical grid, which can create safety hazards. For example, there are scenarios when the PV string should be isolated from the inverter when a so-called string disconnect condition occurs. Disconnect conditions can occur for various reasons, such as maintenance or repairs, equipment faults or failures, electrical grid faults, high resistance conditions, safety code requirements, and pre-installation to name a few. For example, certain safety codes have a “rapid shutdown” requirement to provide a zone outside of which the potential for shock hazards has been mitigated. Such a rapid shutdown that responds to these string disconnect conditions has been provided by rapid shutdown devices (RSDs) that disconnect a respective PV panel or the entire string from the inverter.

The cost of having an RSD for each PV panel can add significant cost to PV systems that have many panels.

It is an object of the following to address the above-noted disadvantages.

### SUMMARY

In one aspect, there is provided a method of controlling a string-level rapid shutdown device in a photovoltaic (PV) solar system comprising one or more strings of PV panels, the method comprising: while the rapid shutdown device is on, opening a pair of power switches used by the rapid shutdown device to connect the PV solar panels to an input of an inverter through a DC disconnect switch on an output side; determining a rate of voltage decay on the output side while the power switches are open; and controlling the power switches according to the rate of voltage decay.

In another aspect, there is provided a string-level rapid shutdown device for a photovoltaic (PV) solar system comprising a string of PV panels, the device comprising: an input side to connect to the PV solar system; an output side to connect to an inverter through a DC disconnect switch; a pair of power switches to connect the input side to the output side; circuitry to measure voltage decay on the output side; and a controller configured to, while the rapid shutdown device is on, open the pair of power switches to determine a rate of voltage decay on the output side while the power switches are open, and to control the power switches according to the rate of voltage decay.

In implementations of the method and device, the string-level rapid shutdown device is connected to a first string of PV panels, wherein the PV solar system further comprises another string-level shutdown device connected to a second string of PV panels connected to the first string of PV panels in parallel. The device is configured for, and the method comprises, controlling the string-level rapid shutdown device to have the power switches open for an overlapping interval with corresponding switches in the other string-level rapid shutdown device.

### BRIEF DESCRIPTION OF THE DRAWINGS

Embodiments will now be described by way of example only with reference to the appended drawings wherein:

FIG. 1A is a schematic block diagram of an example of a PV solar system comprising a string of PV panels;

FIG. 1B is a schematic block diagram of an example of a PV solar system comprising a pair of strings of PV panels;

FIG. 2 is a circuit diagram for a string-level rapid shutdown device (SRSD);

FIG. 3 is a flow chart illustrating computer executable instructions for detecting the state of a DC disconnect switch when an SRSD is in an off state;

FIG. 4 is a flow chart illustrating computer executable instructions for detecting the state of the DC disconnect switch when the SRSD is on and delivering power to a string inverter; and

FIG. 5 is a flow chart illustrating computer executable instructions for controlling multiple SRSDs in a multi-parallel-string PV solar system.

### DETAILED DESCRIPTION

Due to potential imbalances in voltage among strings containing PV panels (or two unequal strings in parallel), sensing current can be ineffective at determining whether or not an inverter is present. To address this concern, the following describes a system and method that monitors the rate of voltage decay on the inverter side of a string-level rapid shutdown device (SRSD). It has been found that the rate of voltage decay on the inverter side (i.e. at the inverter input) has a direct correlation to the impedance on that line, and thus whether the inverter capacitance is present or not, thereby sensing the presence of the inverter. In this way, the SRSD can determine when a closed DC disconnect switch is opened, and as a consequence, disconnect the PV string from the inverter.

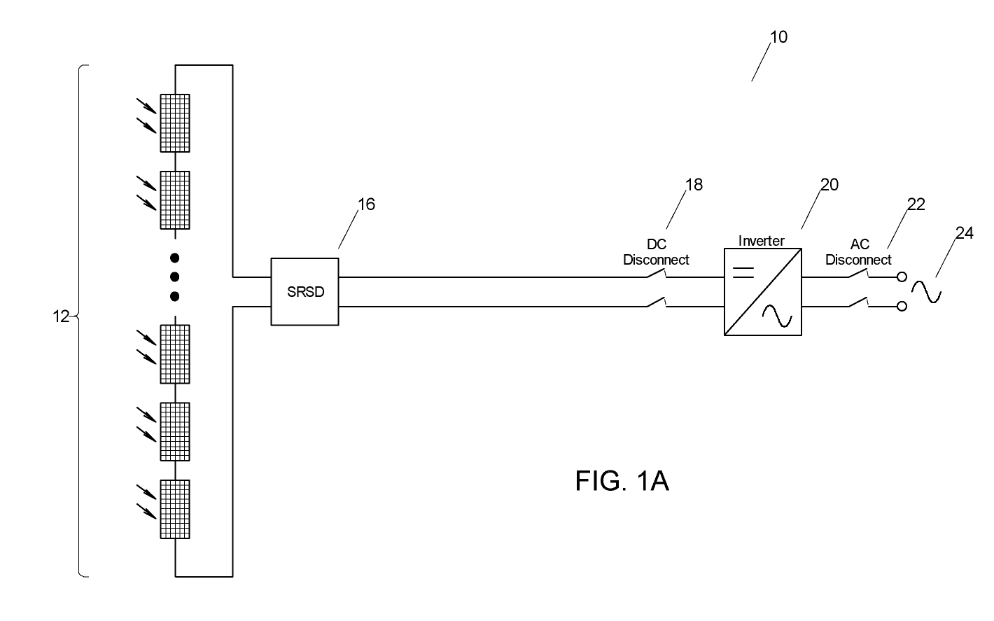

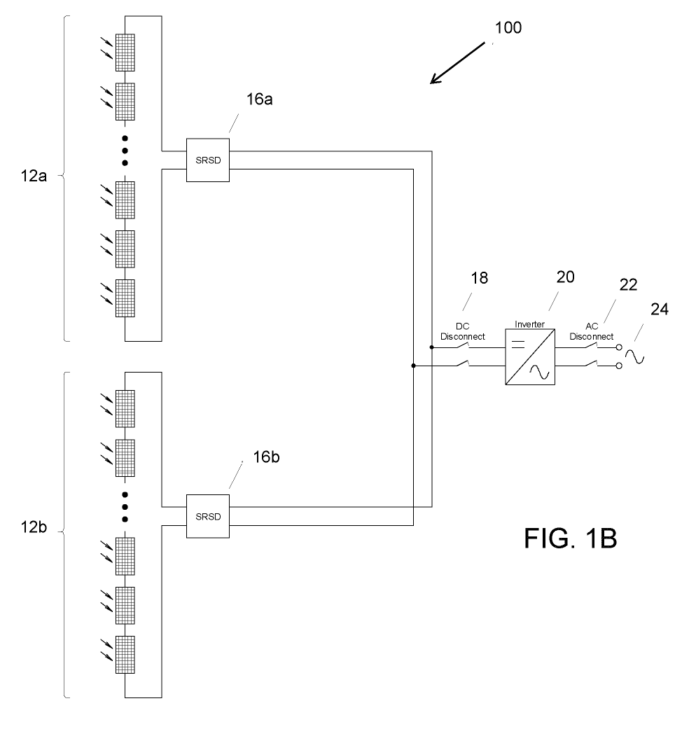

Turning now to the figures, FIG. 1A is a schematic block diagram illustrating an example of a PV system 10. The PV system 10 in this example includes a string 12 composed of a number of PV panels 14 connected in series. The string 12 is connected to an SRSD 16, which is operable to perform rapid shutdown operations at the string level, rather than requiring individual RSDs for each PV panel 14. The SRSD 16 is operationally connected to an inverter 20 through a DC disconnect switch 18. The inverter 20 is operationally connected to an electrical grid 24 through a grid disconnect switch 22. The inverter 20 converts the DC power generated by the PV panels 14 to AC power that is fed into the electrical grid 24. It can be appreciated that the electrical grid 24 can be of any size and configuration, ranging from large multi-national, national, or regional utility grids to smaller standalone grids. It can also be appreciated that the configuration shown in FIG. 1A is illustrative only, for example, multiple strings 12 can be connected to the inverter 20 through multiple SRSDs 16 and DC disconnect switches 18.

The relative locations of the components shown in FIG. 1A can also vary based on the specific installation, local regulations and standards, etc. For example, the SRSD 16 may be located close to the PV panel string 12 while the other components are located remotely therefrom.

FIG. 1B illustrates another PV system 100, which in this example includes a first string 12a that is connected to a first SRSD 16a, and a second string 12b that is connected to a second SRSD 16b. The strings 12a, 12b, and the SRSDs 16a, 16b are connected in parallel to the DC disconnect switch 18 and in turn to the other components 20, 22, 24 shown in FIG. 1A.

In general, the SRSD 16 monitors the status of the DC disconnect switch 18 and disconnects the PV string 12 from the inverter 20 if the DC-disconnect switch 18 has been opened. After disconnecting the panel string 12 in response to a string disconnect condition, the SRSD 16 can be used to determine whether or not the string disconnect condition has been resolved and thus whether or not the panel string 12 can be reconnected to the inverter 20. This can be done by checking electrical continuity between the output of the SRSD 16 and the input of the inverter 20. If there is no electrical continuity to the input of the inverter 20, this can be considered indicative of the DC disconnect switch 18 being open.

On the other hand, if there is electrical continuity to the inverter 20, this could be indicative of the DC disconnect switch 18 being closed and that it would therefore be safe to have the SRSD 16 connect the panel string 12 to the inverter 20.

The SRSD 16 includes continuity testing circuitry that is coupled to the DC disconnect switch 18 and to the PV string 12, to enable the monitoring of the DC disconnect switch 18. The SRSD 16 also includes one or more controllers or control circuitry that can react or respond to the detection of a disconnect condition.

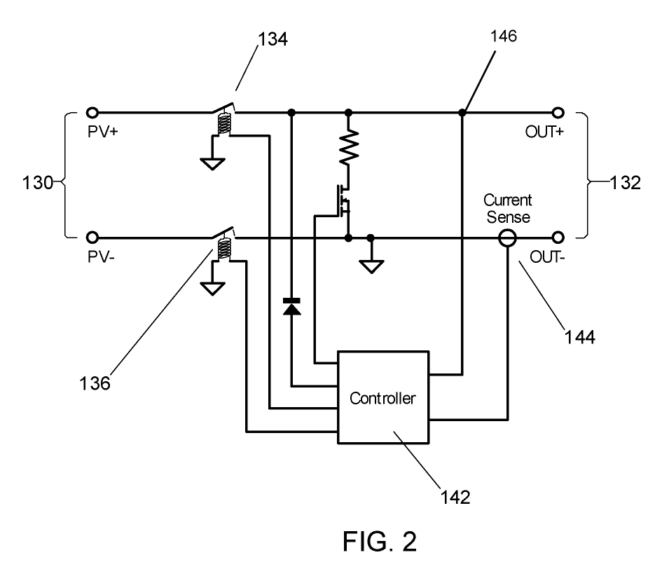

An example of a circuit topology for the SRSD 16 is shown in FIG. 2. The SRSD 16 includes a pair of input terminals 130 connected to the PV string 12, and a pair of output terminals 132 connected to the DC disconnect switch 18. A first power switch 134 is interposed between the positive input and positive output terminals, and a second power switch 136 is interposed between the negative input and negative output terminals. The power switches 134, 136 are used to control whether or not there is electrical continuity through the SRSD 16 to connect or disconnect the PV string 12 to/from the DC disconnect switch 18. Various types of power switches 134, 136 can be used, for example field effect transistors (FETs) such as MOSFETs, bipolar transistors, IGBTs, electromagnetic relays, etc. The power switches 134, 136 are controlled by a controller 142 to have the power switches 134, 136 selectively opened and closed to control the delivery of power to the inverter 20 via the DC disconnect switch 18. It can be appreciated that while a pair of power switches 134, 136 is shown in the examples presented herein, the SRSD 16 can also be configured to include a single power switch. As such, any reference made to controlling the pair of power switches 134, 136 can equally apply to controlling single switch in such a configuration. The SRSD 16 also includes current sensing circuitry 144 for measuring current flow in the SRSD 16, these measurements being provided to the controller 142. It can be appreciated that the controller 142 can be an off-the-shelf integrated circuit, microcontroller, FPGA, ASIC, etc.; or can be a customized set of components. Various other components may be included in the SRSD 16 but have been omitted from FIG. 2 for ease of illustration.

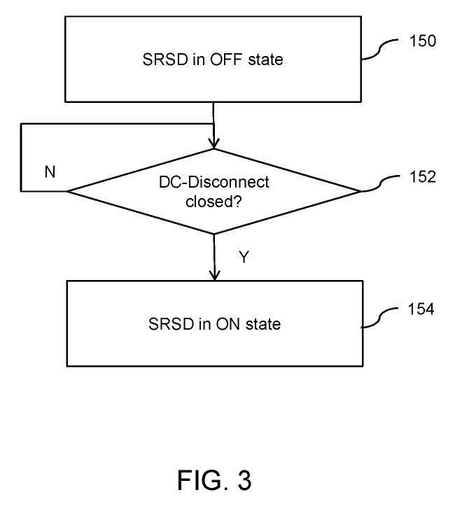

When the SRSD 16 is in the “OFF” state, i.e. before connecting the PV string 12 to the inverter 20, the controller 42 implements computer executable instructions such as those shown in FIG. 3, in order to detect the state of the DC disconnect switch 18. As shown in FIG. 3, when the SRSD 16 is in the OFF state at step 150, and the controller 142 determines at step 152 that the DC-disconnect switch 18 is closed, the controller 142 closes the switches 134, 136 and the SRSD 16 is then in the ON state at step 154.

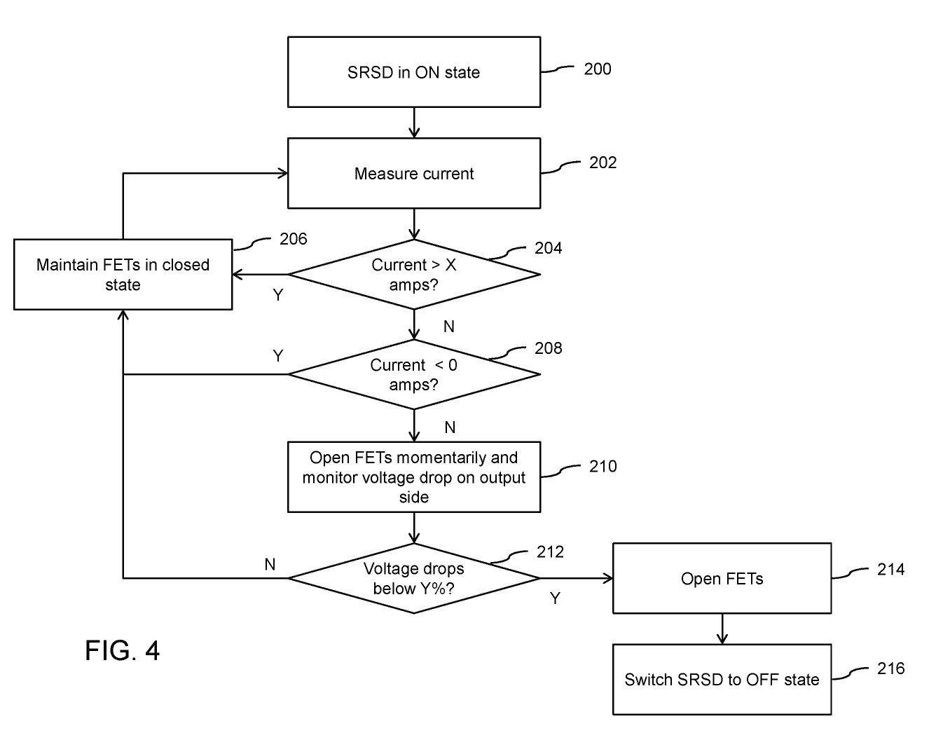

Turning now to FIG. 4, a set of computer executable instructions are shown that can be implemented by the controller 142 in order to detect the state of the DC disconnect switch 18 when the SRSD 16 is in the “ON” state and delivering power to the string inverter 20. As explained in greater detail below, when the SRSD 16 is in the ON state, the power switches 134, 136 are momentarily opened and, after a short period of time with the power switches 134, 136 open, the output voltage on the inverter side of the power switches 134, 136 is measured to determine the rate of voltage decay on that line. As indicated above, this rate of voltage decay has been found to have a direct correlation to the impedance on the line, which in turn is indicative of the presence of inverter capacitance.

At step 200, the SRSD 16 is in the ON state. The controller 142 uses the current sensing circuitry 144 at step 202 to measure the current flow in the SRSD 16. Within certain ranges of current, the process performs certain corresponding operations as follows.

At step 204, the controller 42 determines whether or not the current is above an upper threshold of X amps, for example 7 amps has been found to be suitable. When it is determined that the SRSD 16 is delivering power at above X amps of positive current flow, the power switches 134, 136 (referred to as FETs in the example shown in FIG. 4 for brevity) are kept closed at step 206. Similarly, at step 208, when it is determined that the current flow is less than 0 amps, the controller 142 presumes a reverse bias state and leaves the switches 134, 136 in the closed (ON) state at step 206. When the controller 142 determines that the current flow is above or equal to 0 amps but below the upper threshold X (for example, below 7 amps and above or equal to 0 amps), the controller 142 opens the switches 134, 136 momentarily at step 210 while monitoring the voltage drop on the output side 132. It can be appreciated that switches 134, 136 can be opened for any suitable duration of time and 5 ms has been found to be sufficient to enable the voltage decay to be monitored at node 146 without shutting down the inverter 20.

The voltage decay during this momentary time period corresponds to a voltage drop on the output side, which is determined at step 212 by measuring the voltage at node 146. If the voltage drops below a particular threshold of Y % of its value when the switches 134, 136 were opened, the controller 142 determines that the DC disconnect switch 18 is open and executes step 214 to open the power switches 134, 136 and the SRSD 16 enters the OFF state at step 216. It has been found that a suitable voltage decay threshold Y is approximately 30% of the original voltage. On the other hand, if it is determined at step 212 that the voltage drop is above Y % (e.g., above 30%) of the original value, the controller 142 determines that the DC disconnect switch 18 is closed, and the power switches 134, 136 are re-closed and stay in the on (closed) state at step 206. The process shown in FIG. 4 is preferably performed on a periodic basis while the current flow is below X amps but above or equal to 0 amps, for example, every 4 or 5 seconds. In general, the voltage decay determination can be made in terms of dV/dt, since the SRSD 16 is looking for the presence of a minimum capacitor size in order to be able to declare the inverter's presence. For example, if dV/dt=i/C<X, one can determine that the inverter 20 is present. When no inverter 20 is present, dV/dt would be quite large, since there is no capacitance.

As illustrated in FIG. 1B, there are PV systems 100 that include multiple parallel strings 12 (e.g., two parallel strings 12a, 12b), which should be controlled such that they are both open for some overlapping interval.

When two strings 12a, 12b are operating at a low inverter input current, in order to detect the open DC disconnect switch 18, the power switches 134, 136 in both SRSDs 16a, 16b should be controlled such that they are both open for some overlapping time interval. This may be done in several implementations, for example: 1) open the switches 134, 136 for long enough to ensure partial overlap; 2) detect when the switches 134, 136 in the other SRSD 16 are open, and then open your own switches 134, 136; and 3) randomize the period between switch openings such that the probability of both being open is deterministic.

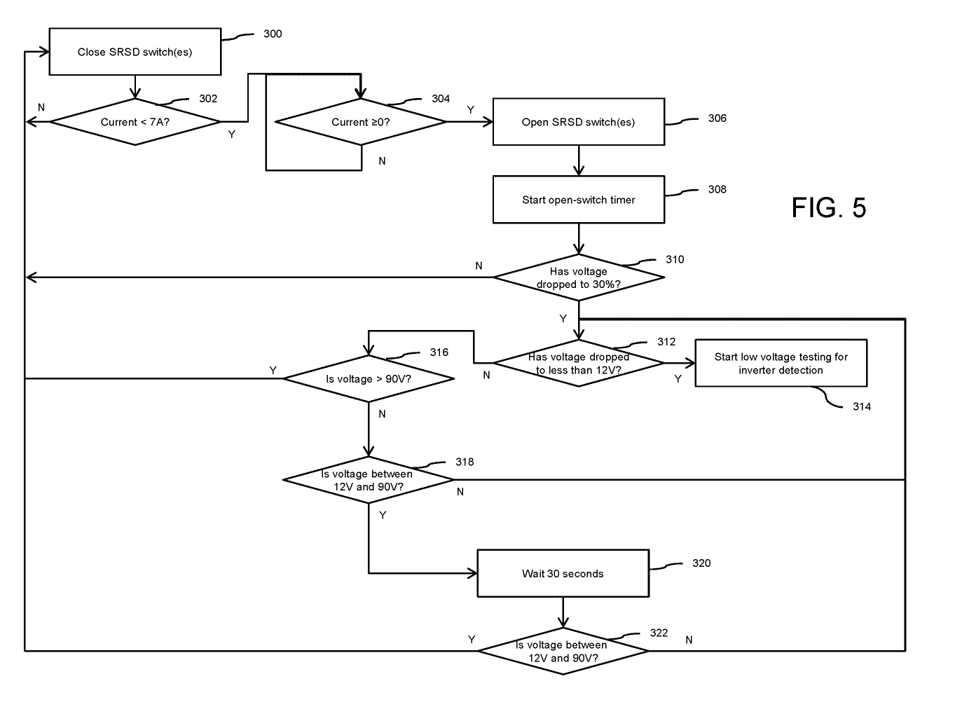

Turning now to FIG. 5, logic is provided for detecting a DC disconnect situation for parallel strings 12a, 12b. At step 300 the SRSD switches 134/136 are closed and a high current threshold is checked at step 302. In this example, the controller 142 determines if the sensed current is above or below 7 A. If the current is above 7 A, this indicates that the inverter 20 is present, since the second parallel string 12b would draw less current in a reverse mode even with a substantial imbalance of illumination. As such, if it is determined at step 302 that the current is not less than 7 A (i.e. is higher), the SRSD switches 134/136 remain closed in a steady state. The controller 142 also determines at step 304 if the current is greater than or equal to zero, i.e. whether or not there is a negative current situation. If so, the periodic opening of the switches 134/136 is not performed as shown by the “No” loop in FIG. 5. As such, when the current is between zero and 7A in this example, the switches 134/136 are opened for a certain amount of time, depending on the voltage detected.

For two strings in parallel 12a, 12b that are in steady state, wherein the switches 134/136 are closed and current is flowing from the PV strings 12a, 12b to the inverter 20, there are two cases to consider for sensing whether or not the DC disconnect switch 18 is open. These two cases are: 1) balanced strings 12; and 2) unbalanced strings 12.

In the first case, with balanced strings 12a, 12b, the SRSDs 16a, 16b would have positive or zero current and would open their power switches 134/136 for a certain amount of time (e.g., 5 ms), on a periodic basis, e.g., every 4.5 to 5 seconds at steps 306 and 308, to determine the voltage on the output side. If the total current is positive, a first of the SRSDs 16a opens its switches 134/136 for a certain amount of time (e.g., 5 ms), and when it is determined that the voltage drops below 30% at step 310, indicating that the inverter 20 is not present, the power switches 134/136 are kept open. The second of the SRSDs 16b then opens its switches 134/136 for the certain amount of time, thus providing an overlapping time when the switches 134/136 are open in both units 16a, 16b.

In this first case, if the total current is zero, or very low, e.g., less than 150 mA, the first SRSD 16a opens its switches 134/136 for a longer period of time, e.g., 150 ms. and if the voltage drop is less than 1V, the first of the SRSDs 16a keeps its switches 134/136 opened for a period of time, e.g., 6 seconds. The second SRSD 16b opens it switches 134/136 for the certain amount of time, every 4.5 to 5 seconds per the above example and, since the first SRSD 16a already has its switches 134/136 opened, both units 16a, 16b would have their switches 134/136 opened for an overlapping interval, in this example, of about 1 to 1.5 seconds.

In the second case, with unbalanced strings 12, a negative current would be flowing from the higher voltage string into the lower voltage string. The SRSD 16a that senses a positive current opens its switches 134/136 for a certain amount of time (e.g., 150 ms for 0 A, or 5 ms for between 0 A and 7 A). At this time, the current in the other SRSD 16b would change from negative to 0 A or otherwise positive. This event would trigger the second SRSD 16b to open its switches 134/136 for 6 seconds. It can be appreciated that at the next iteration when the first SRSD 16a opens its switches 134/136 for the certain amount of time, i.e. after 4.5 to 5 seconds, since the second SRSD 16b has already opened its switches 134/136 both units 16a, 16b would have their switches 134/136 opened for an overlapping interval, for example, 1 to 1.5 seconds.

As also shown in FIG. 5, when the voltage has dropped to 30% or lower at step 310, the controller 142 determines at step 312 whether or not the voltage has dropped to less than 12V. If so, that SRSD 16 starts a low voltage test for inverter detection at step 314 by sending 12V pulses to determine if the inverter 20 is present or not. If the voltage has not dropped below 12V, the controller 142 determines if the voltage is greater than 90V at step 316. If there are two strings in parallel, and the DC disconnect switch 18 is closed (i.e. the inverter 20 is present), one SRSD 16 connects first. The second SRSD should see a voltage of 90V (or higher) and then stops looking for the inverter 20 and connects immediately as shown in FIG. 5. If the voltage is determined at step 318 to be above 12V but less than 90V, the SRSD 16 waits for a period of time, e.g., 30 seconds at step 320 and checks the voltage again at step 322. If the voltage has not changed, then the SRSD closes its switches 134/136.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the SRSD 16, any controller 142 or other component thereof or related thereto, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of controlling a string-level rapid shutdown device in a photovoltaic (PV) solar system comprising one or more strings of PV panels, the method comprising:
while the rapid shutdown device is on, opening a pair of power switches used by the rapid shutdown device to connect the PV solar panels to an input of an inverter through a DC disconnect switch on an output side;
determining a rate of voltage decay on the output side while the power switches are open; and
controlling the power switches according to the rate of voltage decay.

2. The method of claim 1, further comprising keeping the power switches open when the rate of voltage decay is indicative of a voltage drop below a predetermined threshold.

3. The method of claim 1, further comprising re-closing the power switches when the rate of voltage decay is indicative of a voltage drop above a predetermined threshold.

4. The method of claim 1, further comprising sensing current flow in the rapid shutdown device prior to determining whether or not to open the pair of power switches to determine the rate of voltage decay.

5. The method of claim 4, further comprising keeping the power switches closed when the sensed current is above a predetermined threshold of positive current flow.

6. The method of claim 4, further comprising keeping the power switches closed when the sensed current is indicative of a reverse bias state.

7. The method of claim 4, further comprising determining the rate of voltage decay when the sensed current is below a predetermined threshold of positive current flow.

8. The method of claim 7, further comprising keeping the power switches open when the rate of voltage decay is indicative of a voltage drop below a predetermined threshold.

9. The method of claim 7, further comprising re-closing the power switches when the rate of voltage decay is indicative of a voltage drop above a predetermined threshold.

10. The method of claim 1, wherein the string-level rapid shutdown device is connected to a first string of PV panels, and wherein the PV solar system further comprises another string-level shutdown device connected to a second string of PV panels connected to the first string of PV panels in parallel, the method further comprising controlling the string-level rapid shutdown device to have the power switches open for an overlapping interval with corresponding switches in the other string-level rapid shutdown device.

11. The method of claim 10, wherein controlling the string-level rapid shutdown device comprises opening the power switches for a predetermined interval that is long enough to ensure a partial overlap.

12. The method of claim 10, wherein controlling the string-level rapid shutdown device comprises detecting when the corresponding switches in the other string-level rapid shutdown device are open, and opening the power switches of the string-level rapid shutdown device thereafter.

13. The method of claim 10, wherein controlling the string-level rapid shutdown device comprises randomizing a period between switch openings to provide a deterministic probability that the switches of both string-level rapid shutdown devices are open for the overlapping interval.

14. A string-level rapid shutdown device for a photovoltaic (PV) solar system comprising a string of PV panels, the device comprising:
an input side to connect to the PV solar system;
an output side to connect to an inverter through a DC disconnect switch;
a pair of power switches to connect the input side to the output side;
circuitry to measure voltage decay on the output side; and
a controller configured to, while the rapid shutdown device is on, open the pair of power switches to determine a rate of voltage decay on the output side while the power switches are open, and to control the power switches according to the rate of voltage decay.

15. The device of claim 14, wherein the controller is further configured to keep the power switches open when the rate of voltage decay is indicative of a voltage drop below a predetermined threshold.

16. The device of claim 14, wherein the controller is further configured to re-close the power switches when the rate of voltage decay is indicative of a voltage drop above a predetermined threshold.

17. The device of claim 14, wherein the controller is further configured to sense current flow in the rapid shutdown device prior to determining whether or not to open the pair of power switches to determine the rate of voltage decay.

18. The device of claim 17, wherein the controller is further configured to keep the power switches closed when the sensed current is above a predetermined threshold of positive current flow.

19. The device of claim 17, wherein the controller is further configured to keep the power switches closed when the sensed current is indicative of a reverse bias state.

20. The device of claim 17, wherein the controller is further configured to determine the rate of voltage decay when the sensed current is below a predetermined threshold of positive current flow.

21. The device of claim 20, wherein the controller is further configured to keep the power switches open when the rate of voltage decay is indicative of a voltage drop below a predetermined threshold.

22. The device of claim 20, wherein the controller is further configured to re-close the power switches when the rate of voltage decay is indicative of a voltage drop above a predetermined threshold.

23. The device of claim 14, wherein the string-level rapid shutdown device is connected to a first string of PV panels, and wherein the PV solar system further comprises another string-level shutdown device connected to a second string of PV panels connected to the first string of PV panels in parallel, the device further configured for controlling the string-level rapid shutdown device to have the power switches open for an overlapping interval with corresponding switches in the other string-level rapid shutdown device.

24. The device of claim 23, wherein controlling the string-level rapid shutdown device comprises opening the power switches for a predetermined interval that is long enough to ensure a partial overlap.

25. The device of claim 23, wherein controlling the string-level rapid shutdown device comprises detecting when the corresponding switches in the other string-level rapid shutdown device are open, and opening the power switches of the string-level rapid shutdown device thereafter.

26. The device of claim 23, wherein controlling the string-level rapid shutdown device comprises randomizing a period between switch openings to provide a deterministic probability that the switches of both string-level rapid shutdown devices are open for the overlapping interval.
